(19) United States
(12) Patent Application Publication
(10) Pub. No.: US 2024/0351664 A1
(43) Pub. Date: Oct. 24, 2024

(54) MOTORIZED MID-DRIVE UNIT

(71) Applicant: RAZOR USA LLC, Cerritos, CA (US)

(72) Inventors: Robert Chen, Cerritos, CA (US); Louis Lu, New Taipei City (TW); Yau Wang, New Taipei City (TW)

(21) Appl. No.: 18/637,996

(22) Filed: Apr. 17, 2024

Related U.S. Application Data
(60) Provisional application No. 63/496,883, filed on Apr. 18, 2023.

(51) Int. Cl. B62M 25/02; B62M 6/55; B62M 9/00

(52) U.S. Cl. CPC B62M 25/02; B62M 6/55; B62M 9/00

(57) ABSTRACT

Various motorized mid-drive units are disclosed. The motorized mid-drive unit can be configured to drive a vehicle, such as a bicycle, having one or more cranks and a driven wheel. The motorized mid-drive unit can include an electric motor, a reducer, a gearbox (which can include one or more gears), a first one-way bearing, and a second one-way bearing. The first one-way bearing can enable power from the electric motor to be delivered to the driven wheel. The second one-way bearing can enable power from the one or more cranks to be delivered to the driven wheel. The reducer can reduce a rotational speed output from the electric motor which may be delivered to the driven wheel. The motorized mid-drive unit can propel the vehicle with the one or more cranks, with the electric motor, and/or simultaneously with the one or more cranks and the electric motor.

### INCORPORATION BY REFERENCE TO ANY PRIORITY APPLICATIONS

This application claims the priority benefit of U.S. Provisional Application No. 63/496,883, filed Apr. 18, 2023, which is hereby incorporated by reference in its entirety. All applications for which a foreign or domestic priority is identified in the Application Data Sheet as filed herewith are hereby incorporated by reference under 37 CFR 1.57.

### BACKGROUND

This disclosure relates generally to wheeled vehicles, such as bicycles and tricycles, including a pedal assembly and a motor assembly.

Wheeled vehicles can be driven by a pedal assembly which rotates a chain wheel axially offset from a driven wheel of the vehicle. A chain can be used to deliver power from the chain wheel to the driven wheel of a vehicle. Such vehicles can alternately be driven by a motor configured to convey power to the driven wheel of a vehicle.

### SUMMARY OF CERTAIN FEATURES

When a motor is also used to drive a chain wheel, operation of the motor can impact the operation of the pedal assembly by driving undesired movement of the pedal assembly. For example, operation of the motor can rotate pedals of the pedal assembly. The presence of the motor can also introduce frictional loss into operation of the pedal assembly. For example, at least a portion of the power generated from a rotation of foot pedals of the pedal assembly can be lost due to friction from the motor. Motors incorporated with wheeled vehicles, such as bicycles, may output a rotational speed that is undesirable (e.g., too fast) and/or that provide low torque. The devices (e.g., gear boxes, mid-drive units, etc.) described herein can at least address one or more of the foregoing problems, or other problems.

In certain embodiments, a gearbox adapted for use on a mid-drive e-bike is disclosed herein. The e-bike can include foot pedals (e.g., pedals) and a driven wheel. The gearbox can include an electric motor, a plurality of gears, a first one-way bearing, and/or a second one-way bearing. The first one-way bearing can enable power from the electric motor to be delivered to the driven wheel. The second one-way bearing can enable power from the foot pedals to be delivered to the driven wheel. The gearbox can enable a user to propel the e-bike with the foot pedals alone, with the electric motor alone, and/or simultaneously with the foot pedals and the electric motor. The gearbox can include a motor reducer that can decrease the output speed of the motor and/or increase torque.

In some variants, a motorized mid-drive unit configured to drive a bicycle having one or more cranks and a driven wheel is disclosed herein. The motorized mid-drive unit can include an electric motor. The motorized mid-drive unit can include a reducer. The reducer can include an eccentric cam. The reducer can include a gear disk coupled to the eccentric cam. The reducer can include a ring gear interfaced with outward-facing teeth of the gear disk. The reducer can include a reducer output gear interfaced with inward-facing teeth of the gear disk. The motorized mid-drive unit can include one or more gears. The motorized mid-drive unit can include a first one-way bearing. The motorized mid-drive unit can include a second one-way bearing. The first one-way bearing can enable power from the electric motor to be delivered to the driven wheel. The second one-way bearing can enable power from the one or more cranks to be delivered to the driven wheel. The reducer can reduce a rotational speed output from the electric motor and delivered to the driven wheel. The motorized mid-drive unit can enable a user to propel the bicycle with the one or more cranks alone, with the electric motor alone, and/or simultaneously with the one or more cranks and the electric motor.

In some variants, the one or more gears can include a chain wheel that can receive power from the electric motor and the one or more cranks to deliver the power to the driven wheel by way of a chain.

In some variants, the one or more gears can include an output gear. The motorized mid-drive unit can include a pedal shaft rotationally coupled to the one or more cranks. The chain wheel can be rotationally coupled to the output gear. The output gear can be rotationally coupled to the pedal shaft.

In some variants, the output gear is rotationally coupled to the pedal shaft by the second one-way bearing.

In some variants, the one or more gears can include a first output gear and a second output gear. The first output gear can be interfaced with the second output gear. The first output gear can facilitate delivering power from the electric motor to the chain wheel. The second output gear can facilitate delivering power from the electric motor and the one or more cranks to the chain wheel.

In some variants, the first one-way bearing can be coupled to the first output gear. The second one-way bearing can be coupled to the second output gear. Rotation of an inner race of the first one-way bearing in a first direction can lock the first one-way bearing to facilitate delivering power from the electric motor to the first output gear. Rotation of an inner race of the second one-way bearing in a second direction can lock the second one-way bearing to facilitate delivering power from the one or more cranks to the second output gear.

In some variants, the eccentric cam can be rotationally coupled to a motor shaft of the electric motor. The eccentric cam can be coupled to the gear disk. The eccentric cam can rotate the gear disk about an ellipsoidal path.

In some variants, the ring gear can reduce a rotational speed of the gear disk as the gear disk interfaces the ring gear along the ellipsoidal path.

In some variants, the gear disk can reduce a rotational speed of the reducer output gear. The reducer output gear can facilitate delivering power from the electric motor to the driven wheel.

In some variants, the gear disk can include a first inner portion and a second inner portion axial spaced apart from each other. The first inner portion can be interfaced with the eccentric cam. The second inner portion can be interfaced with the reducer output gear.

In some variants, the gear disk can increase an amount of torque from the electric motor and delivered to the driven wheel.

In some variants, the gearbox can form part of a mid-drive unit axially offset from an axis of rotation of the driven wheel.

In some variants, a gearbox for a bicycle is disclosed herein. The gearbox can include a motor. The gearbox can include a reducer. The reducer can include a cam. The reducer can include a gear disk coupled to the cam. The reducer can include a ring gear interfaced with outer teeth of the gear disk. The reducer can include an output gear interfaced with inner teeth of the gear disk. The gearbox can include a first one-way bearing coupled to the output gear. The gearbox can include a first output gear coupled to the first one-way bearing. The gearbox can include a second one-way bearing coupled to a shaft. The gearbox can include a second output gear that can be coupled to the second one-way bearing. The second output gear can be interfaced with the first output gear. The motor can deliver power by way of the reducer to the first one-way bearing to drive the first output gear to rotate the second output gear to rotate a chain wheel. The shaft can rotate from pedaling by a user to deliver power to the second one-way bearing to drive the second output gear to rotate the chain wheel. The first one-way bearing and the second one-way bearing can enable rotation of the chain wheel by power delivered from the motor and not rotation of the shaft from pedaling, by power delivered from rotation of the shaft from pedaling and not the motor, and/or simultaneously by power from the motor and rotation of the shaft by pedaling.

In some variants, the cam can be an eccentric cam that can rotate the gear disk about a first axis offset from a second axis of a motor shaft of the motor.

In some variants, the outer teeth of the gear disk can engage teeth of the ring gear to slow a rotational speed of the gear disk.

In some variants, a gearbox that can be coupled to a bicycle is disclosed herein. The gearbox can include an electric motor including a housing and a motor shaft. The gearbox can include an eccentric cam coupled to the motor shaft of the electric motor. The electric motor can rotate the eccentric cam about the motor shaft. The gearbox can include a gear disk that can be coupled to the eccentric cam. The eccentric cam can rotate the gear disk on an ellipsoidal path. The gearbox can include a ring gear that can interface with an outer periphery of the gear disk. The ring gear can be fixed relative to the housing. The ring gear can reduce a rotational speed of the gear disk. The gearbox can include an output gear that can interface with an inner periphery of the gear disk. The gear disk can reduce a rotational speed of the output gear. The output gear can deliver motive power to a driven wheel of the bicycle.

In some variants, the eccentric cam can be coupled to a first inner portion of the gear disk that is free of gear teeth.

In some variants, the inner periphery of the gear disk can include a plurality of gear teeth that can engage outer gear teeth of the output gear.

In some variants the outer periphery of the gear disk can include outer gear teeth that can interface with inner gear teeth of the ring gear along the ellipsoidal path.

In some variants, the output gear can rotate a first one-way bearing in a locked configuration to rotate a first output gear. The first output gear can be interfaced with a second output gear. The rotation of the second output gear can drive a chain wheel of the bicycle to provide motive power to the bicycle.

In some variants, a gearbox for a vehicle including a driven wheel and a pedal assembly including a chain wheel and a shaft is disclosed herein. The gearbox can include a motor assembly including an output shaft. The gearbox can include a motor reducer assembly. The motor reducer assembly can include a cam disposed on the output shaft. The cam can include an eccentric profile. The motor reducer assembly can include a gear disk coupled to the cam. The motor reducer assembly can include a ring gear interfaced with outer teeth of the gear disk. The motor reducer assembly can include an output gear interfaced with inner teeth of the gear disk. The motor reducer assembly can drive rotation of the output gear at a reduced speed relative to a rotational speed of the output shaft of the motor assembly. The gearbox can include a first one-way bearing coupled to the output gear. The gearbox can include a first output gear coupled to the first one-way bearing. The gearbox can include a second one-way bearing configured to be coupled to the shaft of the pedal assembly. The gearbox can include a second output gear coupled to the second one-way bearing. The second output gear can be interfaced with the first output gear and coupled to a chain wheel of the pedal assembly. The motor assembly can rotate the output shaft to drive rotation of the first output gear to rotate the second output gear and chain wheel to drive rotation of the driven wheel to propel the vehicle. The shaft of the pedal assembly can rotate from pedaling to drive rotation of the second output gear and the chain wheel to drive rotation of the driven wheel to propel the vehicle. The first one-way bearing can slip to enable the shaft of the pedal assembly to drive rotation of the second output gear without driving rotation of the output shaft. The second one-way bearing can slip to enable the output shaft of the motor assembly to drive rotation of the first output gear to rotate the second output gear without driving rotation of the shaft of the pedal assembly.

In some variants, the first one-way bearing and the second one-way bearing can slip to enable simultaneous rotation of the output shaft and the shaft of the pedal assembly.

In some variants, the pedal assembly can include a chain coupling the chain wheel and a sprocket of the driven wheel.

In some variants, the motor reducer assembly can increase a torque delivered by the motor assembly.

In some variants, the ring gear can increase a torque delivered by the motor assembly.

In some variants, the gear disk can increase a torque delivered by the motor assembly.

In some variants, the interface between the ring gear and the outer teeth of the gear disk can slow rotation of the gear disk relative to the output shaft.

In some variants, the interface between the output gear and the inner teeth of the gear disk can slow rotation of the output gear relative to the gear disk.

In some variants, the cam can rotate the gear disk on an ellipsoidal path.

In some variants, the ellipsoidal path is off an axis of rotation of the output shaft.

In some variants, a motor unit for a vehicle with a pedal assembly is disclosed herein. The motor unit can include a motor assembly including an output shaft. The motor unit can include a motor reducer assembly. The motor reducer assembly can include a cam disposed on the output shaft. The cam can include an eccentric profile. The motor reducer assembly can include a gear disk coupled to the cam. The motor reducer assembly can include a ring gear interfaced with outer teeth of the gear disk. The motor reducer assembly can include an output gear interfaced with inner teeth of the gear disk. The motor reducer assembly can drive rotation of the output gear at a reduced speed relative to a rotational speed of the output shaft of the motor assembly.

In some variants, the motor reducer assembly can increase a torque delivered by the motor assembly.

In some variants, the interface between the gear disk and the ring gear can increase a torque delivered by the motor assembly.

In some variants, the gear disk can increase a torque delivered by the motor assembly.

In some variants, the interface between the ring gear and the outer teeth of the gear disk can slow rotation of the gear disk relative to the output shaft.

In some variants, the interface between the output gear and the inner teeth of the gear disk can slow rotation of the output gear relative to the gear disk.

In some variants, the cam can rotate the gear disk on an ellipsoidal path.

In some variants, the ellipsoidal path can be off an axis of rotation of the output shaft.

In some variants, a gearbox for a vehicle with a driven wheel and a pedal assembly including a chain wheel and a shaft is disclosed herein. The gearbox can include the motor unit.

In some variants, the gear box can include a first one-way bearing coupled to the output gear. The gear box can include a first output gear coupled to the first one-way bearing. The gear box can include a second one-way bearing that can be coupled to the shaft of the pedal assembly. The gear box can include a second output gear that can be coupled to the second one-way bearing. The second output gear can be interfaced with the first output gear. The second output gear can be coupled to a chain wheel of the pedal assembly. The motor assembly can rotate the output shaft to drive rotation of the first output gear to rotate the second output gear and chain wheel to drive rotation of the driven wheel to propel the vehicle. The shaft of the pedal assembly can rotate from pedaling to drive rotation of the second output gear and the chain wheel to drive rotation of the driven wheel to propel the vehicle. The first one-way bearing can slip to enable the shaft of the pedal assembly to drive rotation of the second output gear without driving rotation of the output shaft. The second one-way bearing can slip to enable the output shaft of the motor assembly to drive rotation of the first output gear to rotate the second output gear without driving rotation of the shaft of the pedal assembly.

In some variants, a motor reducer unit for a vehicle with a pedal assembly is disclosed herein. The motor reducer unit can include a cam disposed on an output shaft of a motor unit. The cam can include an eccentric profile. The motor reducer unit can include a gear disk coupled to the cam. The motor reducer unit can include a ring gear interfaced with outer teeth of the gear disk. The motor reducer unit can include an output gear interfaced with inner teeth of the gear disk. The motor reducer unit can drive rotation of the output gear at a reduced speed relative to a rotational speed of the output shaft of the motor unit.

In some variants, a gearbox for a vehicle with a pedal assembly and a driven wheel is disclosed herein. The gearbox can include a motor including an output shaft. The gearbox can include a first output gear disposed on the output shaft with a first one-way bearing disposed between the output shaft and the first output gear. The output shaft can drive rotation of the first output gear. The gearbox can include a second output gear interfaced with the first output gear. The second output gear can be disposed on a shaft of the pedal assembly with a second one-way bearing disposed between the shaft and the second output gear. The shaft can drive rotation of the second output gear. The motor can drive the output shaft to drive the first output gear to rotate the second output gear to rotate a chain wheel of the pedal assembly coupled to the second output gear to drive rotation of the driven wheel. The shaft of the pedal assembly can drive the second output gear to rotate the second output gear to rotate the chain wheel of the pedal assembly coupled to the second output gear to drive rotation of the driven wheel. The first one-way bearing can slip to enable the first output gear to rotate at a different speed than the output shaft. The second one-way bearing can slip to enable the second output gear to rotate at a different speed than the shaft. The gearbox can include a reducer that can decrease a rotational speed of the output shaft relative to a rotational speed driven by the motor.

Neither the preceding Summary nor the following Detailed Description and associated drawings purport to limit or define the scope of protection. The scope of protection is defined by the claims.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only certain embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise.

FIG. 1A illustrates a perspective view of an embodiment of a vehicle including a pedal assembly and a mid-drive unit including a motor assembly to propel the vehicle.

FIG. 1B illustrates a left side view of the vehicle of FIG. 1A.

FIG. 1C illustrates a top plan view of the vehicle of FIG. 1A.

FIG. 1D illustrates a right side view of the vehicle of FIG. 1A.

FIG. 1E illustrates a right side view of the vehicle of FIG. 1A with a chain and sprocket.

FIG. 2A illustrates a perspective view of the gearbox of the vehicle of FIG. 1A, shown independent of the vehicle.

FIG. 2B illustrates a left side view of the gearbox of FIG. 2A.

FIG. 2C illustrates a top plan view of the gearbox of FIG. 2A.

FIG. 2D illustrates a right side view of the gearbox of FIG. 2A.

FIG. 3A illustrates a perspective view of certain components of the gearbox of FIG. 2A without a housing.

FIG. 3B illustrates a perspective view of components of the gearbox FIG. 2A with certain components removed.

FIG. 3C illustrates a top view of components of the gearbox of FIG. 2A.

FIG. 3D schematically illustrates a cross sectional view of components of the gearbox of FIG. 2A.

FIG. 4A schematically illustrates components of the gearbox of FIG. 2A.

FIG. 4B shows the schematic illustration of FIG. 4A with a power path schematically shown for motive power provided with the pedal assembly.

FIG. 4C shows the schematic illustration of FIG. 4A with a power path schematically shown for motive power provided with the motor assembly.

FIG. 4D shows the schematic illustration of FIG. 4A with combined power paths schematically shown for motive power provided with both the pedal assembly and the motor assembly (e.g., concurrently).

FIG. 5A illustrates a perspective view of components of the gearbox of FIG. 2A, including the motor assembly with a motor and a reducer.

FIG. 5B illustrates a cross sectional view of the motor unit of FIG. 5A, including the motor and the reducer.

FIG. 5C illustrates an exploded view of the motor unit of FIG. 5A, including the motor and the reducer.

### DETAILED DESCRIPTION OF CERTAIN EMBODIMENTS

The disclosed technology relates to motorized drive units that can be used with a vehicle, such as an electric bicycle (e-bike). At least some components of the motorized drive unit can be positioned in a middle section of the vehicle, such as between a front and rear wheel of a vehicle. In some embodiments, the components positioned in the middle section of the vehicle can include a motorized mid-drive unit, which can be used with an electric bicycle, also referred to as a mid-drive e-bike. Such motorized mid-drive units can be configured for use on a variety of vehicles, including bicycles, tricycles, and/or other pedaled vehicles. Certain embodiments of the mid-drive unit, and components thereof, are disclosed in the accompanying figures, which form a part hereof. In certain embodiments, a mid-drive unit can include a small motor, speed reducing gears, and/or at least two one-way bearings. The present disclosure can be implemented in, and include the technology described in, and include any of the features disclosed in, U.S. Patent Application Publication No. 2022/0371686, which is incorporated by reference herein in its entirety.

### A. Overview

In certain embodiments, a mid-drive vehicle (e.g., e-bike) can include a gearbox, which can also be referred to as a gear case and/or transmission. The mid-drive vehicle can include a driven wheel (e.g., rear wheel), a chain wheel (e.g., chain gear), pedal assembly with a crank, and/or a bottom bracket shaft. The driven wheel can be various sizes, which can include approximately 27.5″ in diameter. The gearbox can be configured to couple (e.g., mate) with a frame of the vehicle. The gearbox can include a coupling (e.g., mounting) feature that can couple (e.g., engage) with the frame. In certain implementations, the gearbox can be positioned (e.g., installed), at least partly, at (e.g., into) a location at which the crank couples (e.g., mounts) to the vehicle (e.g., bottom bracket shaft). In some variants, the gearbox can be positioned (e.g., installed) without modifying the frame of the vehicle. The gearbox can facilitate converting and/or retrofitting of a non-powered vehicle into a powered vehicle (e.g., non-powered bike into a powered bike).

The gearbox can include a motor, a reducer, one or more gears, a first one-way bearing, and/or a second one-way bearing. The motor can be powered by a battery, which can be positioned in or adjacent to the gearbox, or elsewhere on the vehicle. The gearbox can include, such as be formed by, only one or a plurality (e.g., two) of pieces of sheet metal. The motor and/or reducer can be disposed between two pieces of sheet metal, wrapped by sheet metal, etc. The gearbox can include an aluminum extrusion part. The motor and/or the reducer can be at least partially surrounded by the aluminum extrusion part. In certain implementations, the gearbox can include a cycloidal gear, harmonic drive, and/or or other eccentric drive mechanism described herein or otherwise.

The gearbox can include one or more gears, which can at least include a first gear and a second gear. The first gear can be coupled to the first one-way bearing. The second gear can be coupled to the second one-way bearing. The first one-way bearing can be configured to enable power from the motor (e.g., electric motor) to be delivered to the driven wheel (e.g., rear wheel) of the vehicle. Power from the electric motor can be transmitted from the electric motor to the first one-way bearing, then to the first gear, then to the second gear, and then to the chain wheel. The chain wheel can drive the driven wheel, which can be facilitated by a chain coupling the chain wheel and the driven wheel. The second one-way bearing can facilitate transmission of power from the bottom bracket shaft of the pedal assembly to the driven wheel. Power from the crank can be transmitted to the bottom bracket shaft, then to the second one-way bearing, then to the second gear, and then to the chain wheel. The gearbox can be configured to enable a user to drive the vehicle by pedaling the one or more cranks of the pedal assembly and the electric motor one at a time and/or simultaneously. In certain implementations, when the motor is driving rotation of the driven wheel, the user can concurrently rotate the foot pedals backward. In various embodiments, pedaling by the user does not drive the motor and/or the motor does not resist pedaling by the user. The motor can be small enough in size to avoid interference with the user pedaling the vehicle.

The reducer can comprise a cam, a gear disk, an output gear, and/or a ring gear. The cam can be coupled to a motor shaft of the motor. The cam can have an eccentric profile and/or can be configured to rotate eccentrically. For example, the cam can have an ellipsoidal profile and/or can be configured to rotate about an axis of rotation that is not collinear with an axial center of the cam. The gear disk can be configured to be coupled to the cam. The outer teeth of the gear disk can interface with the ring gear, which can manage (e.g., lower) a rotational speed of the gear disk relative to a rotational speed of the motor shaft of the motor. The inner teeth of the gear disk can interface with the outer teeth of the output gear, which can manage (e.g., lower) a rotational speed of the output gear relative to the rotational speed of the gear disk. The output gear can be coupled to the first gear, which can include by way of the first one-way bearing. Accordingly, the reducer can reduce the rotational speed of the first gear relative to the motor shaft, which can increase torque. The gearbox can form part of a mid-drive unit axially offset from an axis of rotation of the driven wheel.

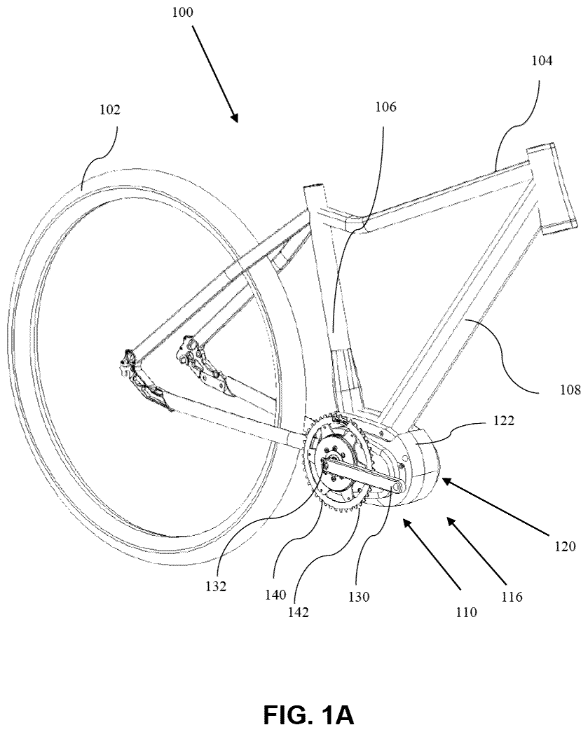

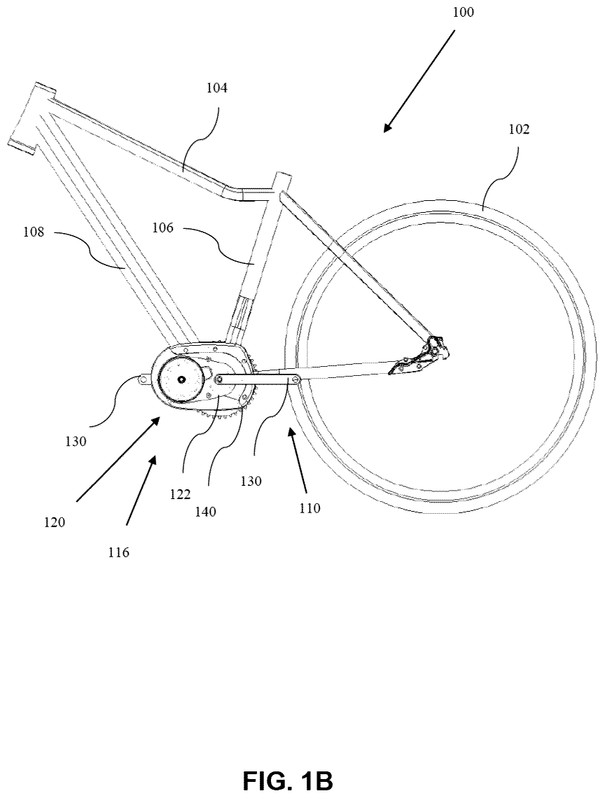

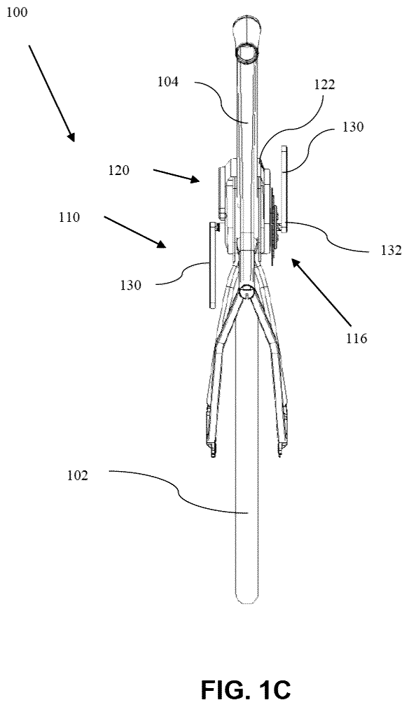

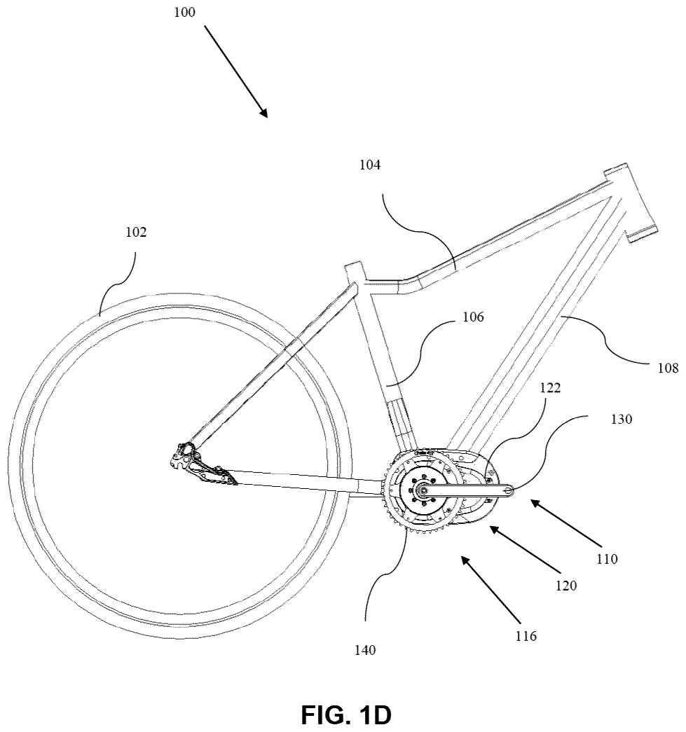

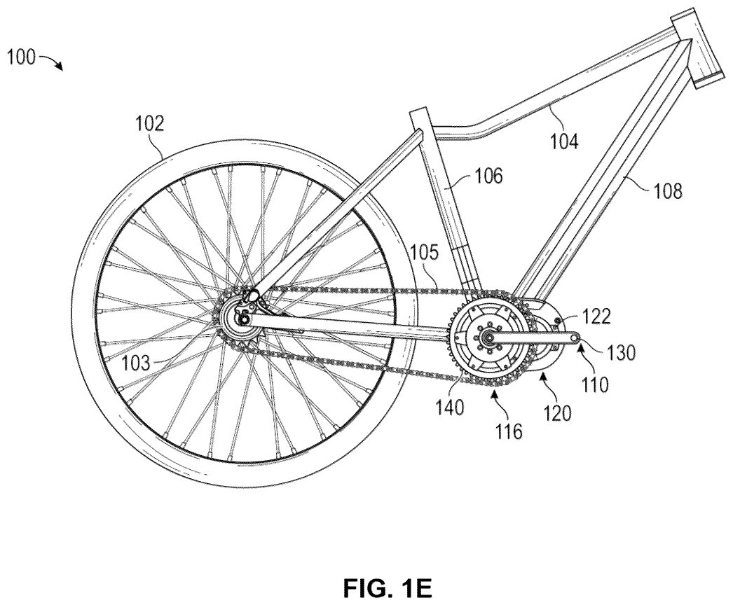

### B. Vehicle with Mid-Drive Unit—FIGS. 1A-1E

FIGS. 1A-IE illustrate various views of a vehicle 100 including a pedal assembly 110 and a mid-drive unit 116 including gearbox 120. The vehicle 100 can be a bicycle (e.g., e-bike), tricycle, or other vehicle. The vehicle 100 can include a driven wheel 102 (e.g., rear wheel) and a frame 104. Although not shown, the vehicle 100 can also include a front wheel. The frame 104 can include a seat tube 106 and a down tube 108 among other features (e.g., seat stay, chain stay, head tube, top tube, etc.).

A gearbox 120 (e.g., gear case, transmission) can be located at or within the region (e.g., proximate) the down tube 108 or its axial projection intersects the seat tube 106 or its axial projection. The gearbox 120 can be located at the intersection of the seat tube 106 and the down tube 108. The gearbox 120 can have a housing 122.

A pedal assembly 110 can include a pedal shaft 132 (e.g., shaft, crank shaft) that can extend through the gearbox 120 (e.g. one side of the shaft 132 protrudes from one side of the gearbox 120 and another side of the shaft 132 protrudes from another side of the gearbox 120). The pedal assembly 110 can include one or more cranks 130 that can be coupled to opposing sides of the pedal shaft 132 (e.g., two cranks juxtaposed on opposing sides of the pedal shaft 132). Although not shown in FIGS. 1A-1E, the one or more cranks 130 may each be connected to and support a pedal at the outer or free end of the one or more cranks 130.

The gearbox 120 can be operatively coupled with or include a torque-transmission device, such as a chain wheel 140 (e.g., chain gear), which can include one or more chain wheel teeth 142. As shown in FIG. 1E, the chain wheel 140 can be operatively coupled with the driven wheel 102 with a chain 105 (e.g., the chain 105 can be routed, such as looped, around a sprocket 103 of the driven wheel 102). The driven wheel 102 can be driven by power transmitted from the chain wheel 140, to the chain 103, and to the sprocket 103 of the driven wheel 102 to rotate the driven wheel 102. For example, the rotation of the chain wheel 140, which can be driven by a user pedaling pedals coupled to the cranks 130, can drive the chain 105 to rotate the rear wheel 102 (e.g., sprocket 103 of the driven wheel 102). The one or more chain wheel teeth 142 can interface the chain 105 to transmit power from the chain wheel 140 to the driven wheel 102. In some implementations, the front wheel can be the driven wheel 102.

As described herein, the gearbox 120 can include a motor assembly (e.g., a motor reducer assembly) that can provide power to drive (e.g., rotate) driven wheel 102 of the vehicle 100. The pedal assembly 110 (e.g., pedal shaft 132, cranks 130, and pedals) can provide power to drive (e.g., rotate) the driven wheel 102 of the vehicle 100. The power can be delivered along at least partially separate paths passing through the gearbox 120 but can converge into a common output segment at a component within the gearbox 120. Prior to the common output segment, the separate power paths can be isolated from one another, such as by respective one-way bearings located along each power path, as discussed in more detail below.

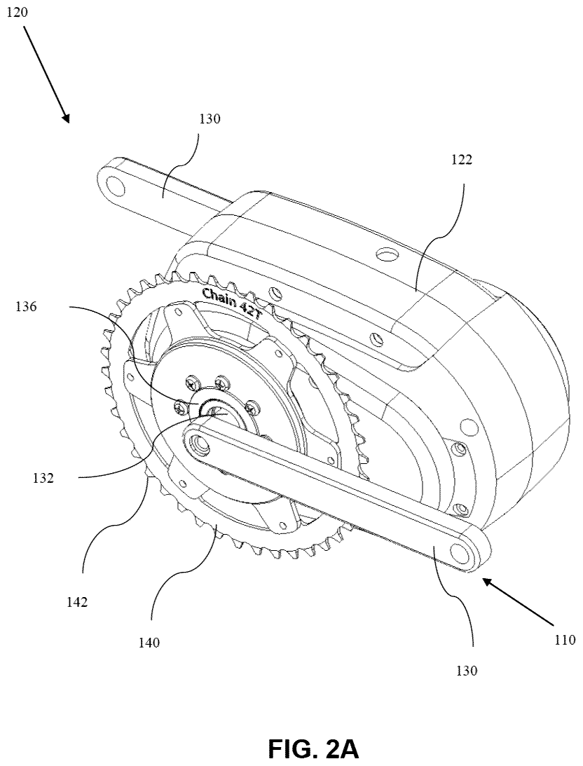

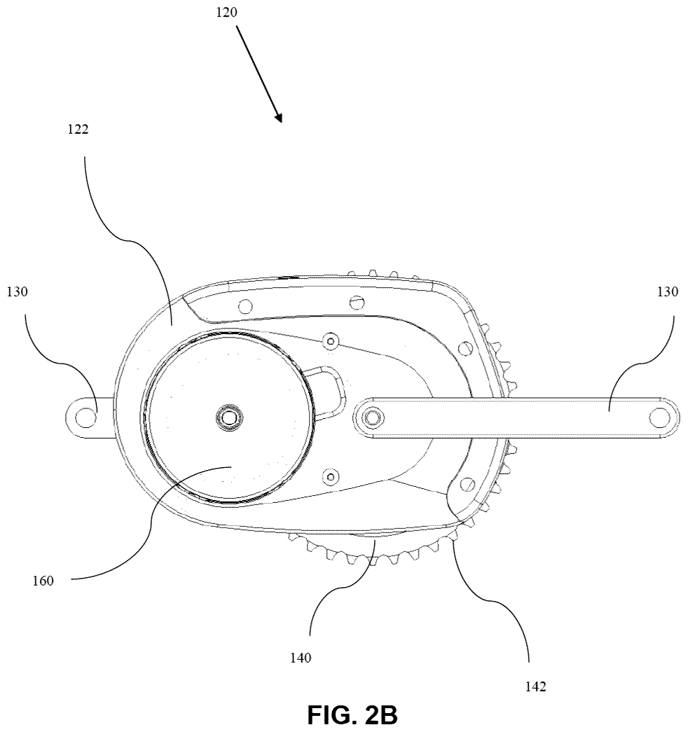

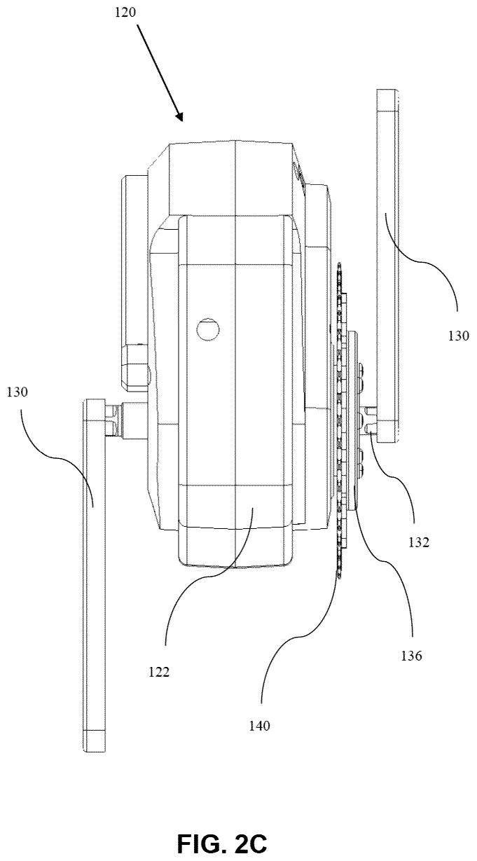

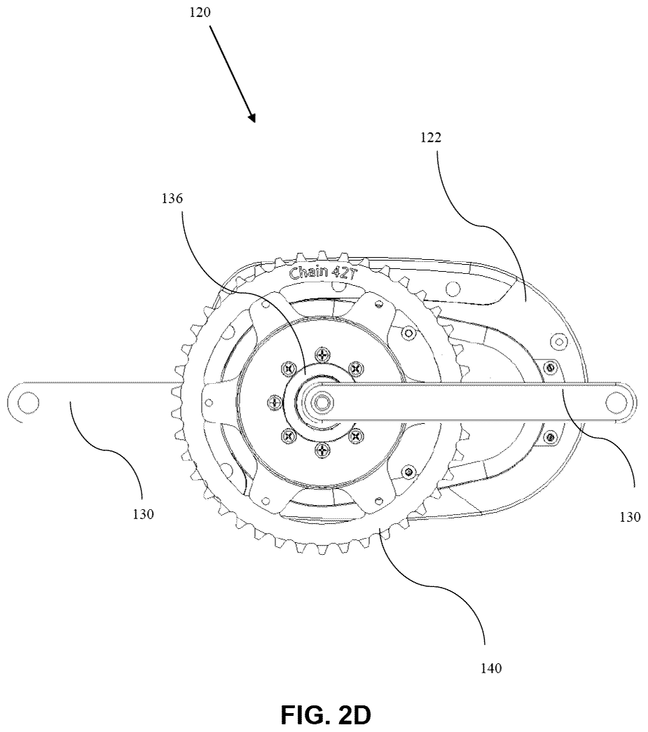

### C. External Features of Gearbox—FIGS. 2A-2D

FIGS. 2A-2D illustrate various views of the gearbox 120 of the vehicle 100 of FIGS. 1A-ID. The gearbox 120 can include a housing 122, which can at least partially enclose a plurality of components (e.g., a motor assembly 160) arranged along different or multiple axes of rotation. The housing 122 can be a variety of materials, which can at least include plastic and/or metal (e.g., die cast metal). The housing 122 may be dimensioned to be insertable or otherwise extend into a space between components of the vehicle frame 104. The housing 122 can be generally oval in shape, though other shapes are contemplated too.

The housing 122 of the gearbox 120 can be coupled (e.g., secured) relative to the frame 104 of the vehicle 100. For example, the gearbox 120 can be assembled on the vehicle 100 or the frame 104 through a crank axle or the pedal shaft 132. The gearbox 120 can be coupled to an intermediate component (e.g., bracket) coupled to the frame 104 and/or directly coupled to the frame 104 (e.g., seat tube 106 and/or down tube 108) via one or more fasteners (e.g., clamp, bolts, screws, etc.). In some embodiments, the gearbox 120 can be welded and/or adhered to the frame 104. In some variants, the gearbox can be an integral component of the frame 104.

As illustrated, the pedal shaft 132 can extend through the housing 122 of the gearbox 120 to protrude from opposing sides of the housing 122. The protruding ends of the pedal shaft 132 can be coupled to the cranks 130, which can be coupled to pedals.

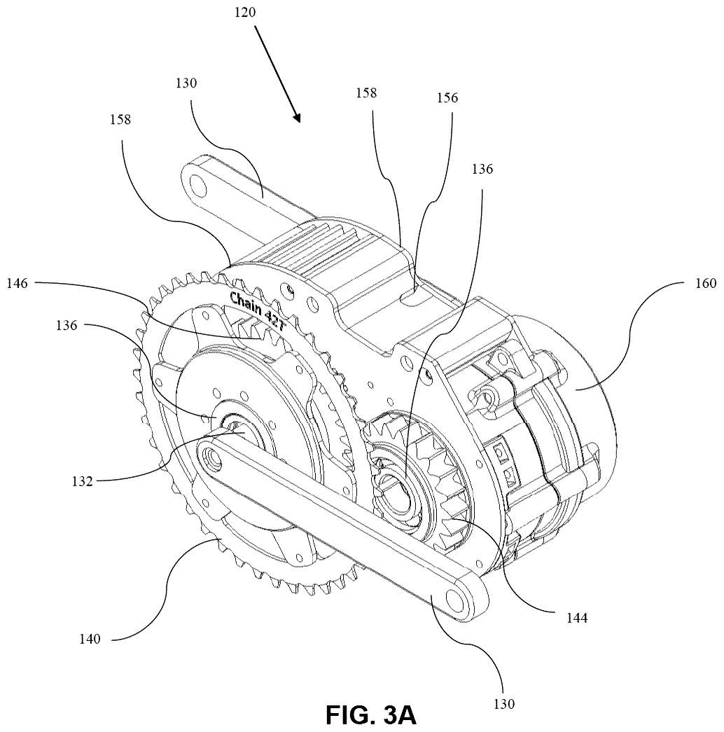

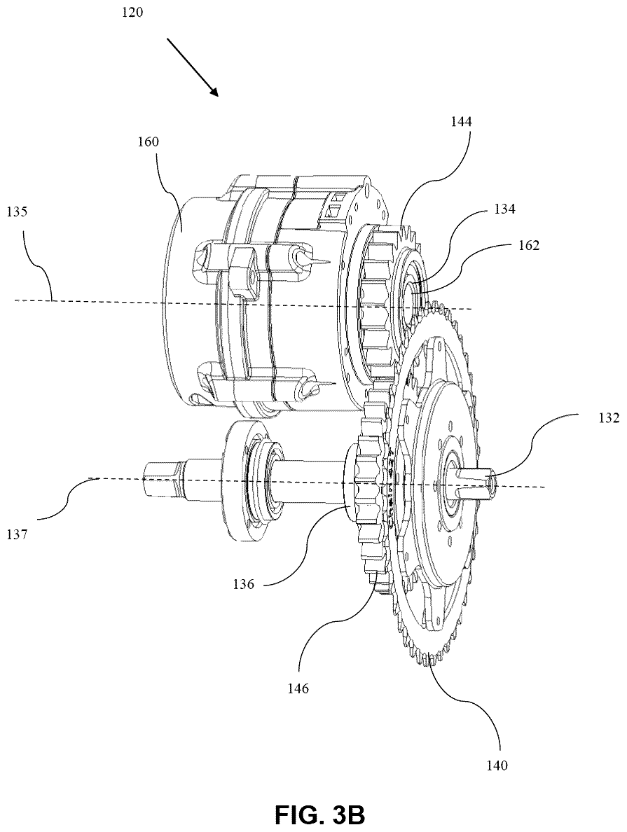

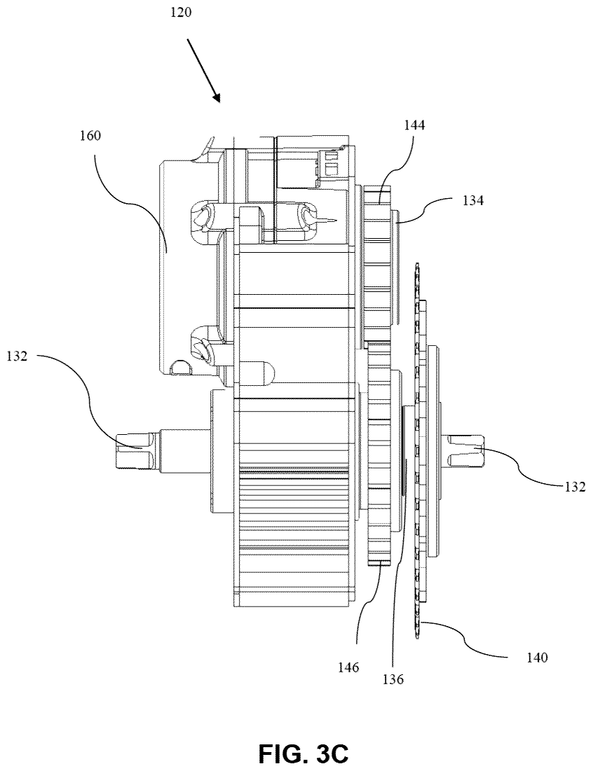

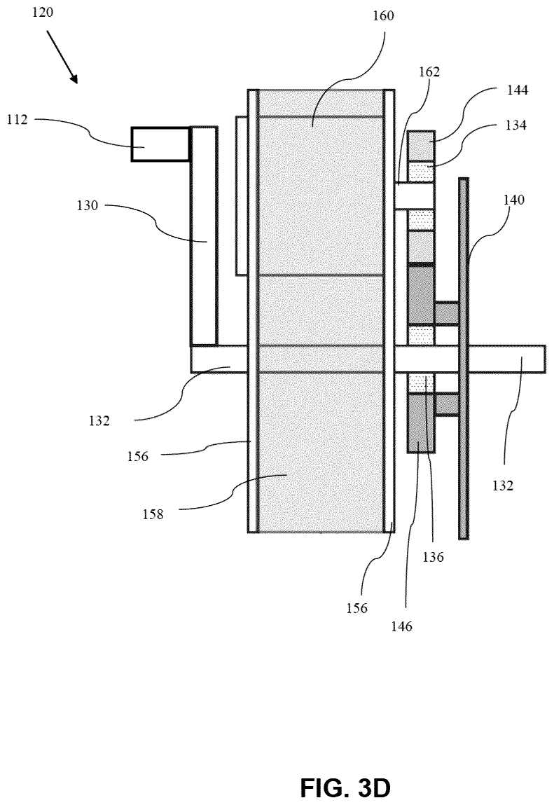

### D. Internal Features of Gearbox—FIGS. 3A-3D

FIGS. 3A-3D illustrate the gearbox 120 with portions of the housing 122 removed to show components within the gearbox 120. FIG. 3A shows a perspective view of the gearbox 120 with one or more pieces of sheet metal 158 (e.g., two pieces of sheet metal) and an extrusion part 156 positioned between the one or more pieces of sheet metal 158 to enclose components of the gearbox 120. For example, the extrusion part 156 and one or more pieces sheet metal 158 can enclose portions of the pedal shaft 132 and the motor assembly 160. FIG. 3B shows a perspective view of the gearbox 120 with the housing 122 removed along with the sheet metal 158 and the extrusion part 156. FIGS. 3C and 3D respectively show top and schematic cross-sectional views of the gearbox 120. For purposes of presentation, the cranks 130 are not shown in FIGS. 3B and 3C and FIG. 3D shows only one of the cranks 130 connected to a pedal 112. As shown, the gearbox 120 can include a motor assembly 160, a first one-way bearing 134 (e.g., motor one-way bearing), first output gear 144 (e.g., motor output gear), a second one-way bearing 136 (e.g., pedal one-way bearing), and/or a second output gear 146 (e.g., pedal output gear). Each of the components of the gearbox 120 can facilitate motive power to move (e.g., propel) the vehicle 100 in a direction (e.g., forward).

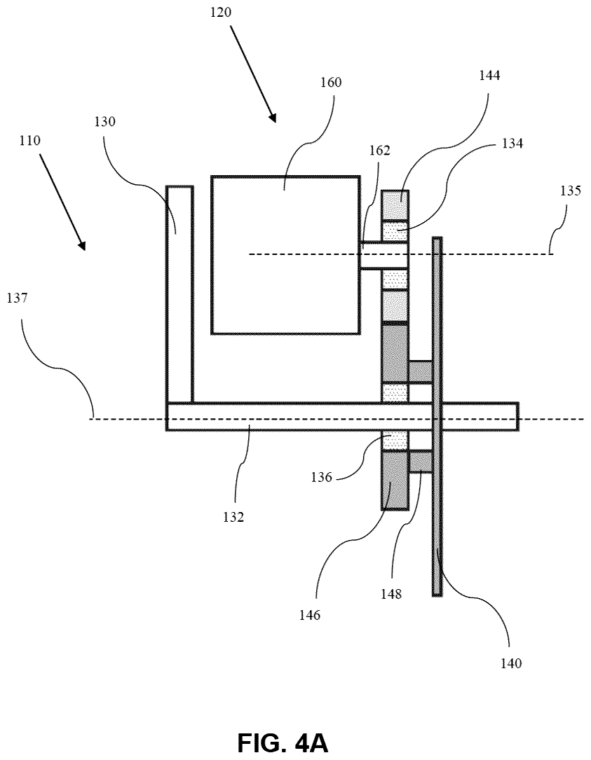

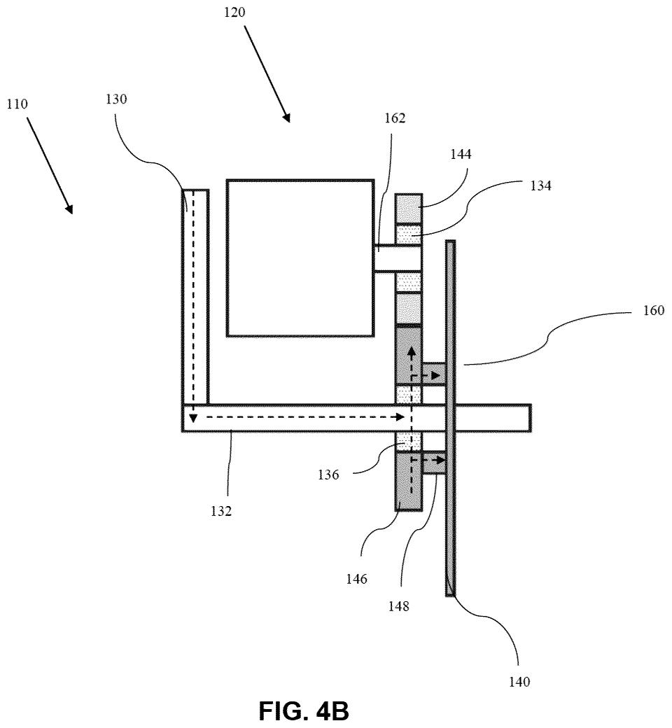

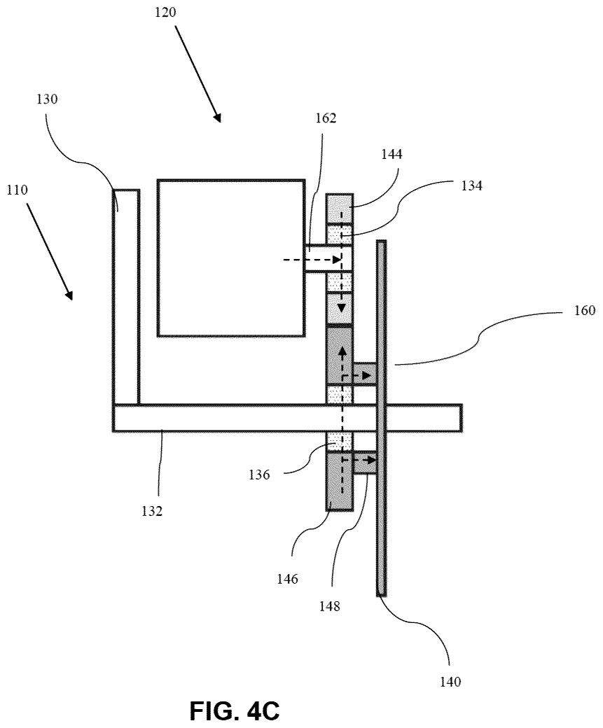

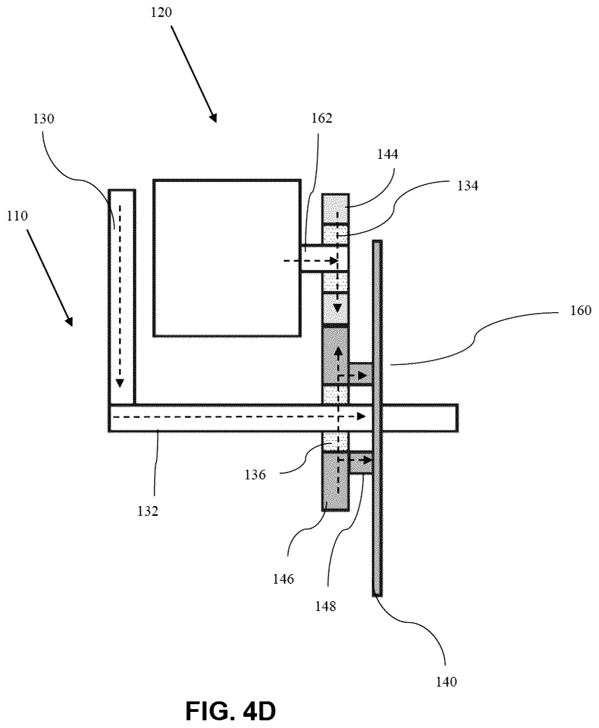

### D. Dual Power Paths of Gearbox—FIGS. 4A-4D

FIGS. 4A-4D schematically illustrate, respectively, components of the gear box 120 with axes of rotation, the power path for motive power provided by the pedal assembly 110 (e.g., via one or more cranks 130), the power path for motive power provided by the motor assembly 160, and combined power paths for motive power simultaneously provided with both the pedal assembly and the motor assembly 160.

As illustrated in FIG. 4A, the gearbox 120 can include a pedal shaft 132 that can rotate about a second rotational axis 137. The pedal shaft 132 can be coupled to and be coaxial with the second one-way bearing 136 (e.g., pedal one-way bearing) and the second output gear 146. The second one-way bearing 136 can be disposed radially between the pedal shaft 132 and the second output gear 146, which can include the second one-way bearing 136 being coupled to the second output gear 146. The second output gear 146 can be coupled to the chain wheel 140, which can include being coupled together by way of a coupling 148 (e.g., annular structure, ring) disposed between the second output gear 146 and the chain wheel 140. The coupling 148, in some variants, is not directly coupled to the pedal shaft 132. The pedal shaft 132, second output gear 146, second one-way bearing 136, coupling 148, and/or chain wheel 140 can be centered about the second axis of rotation 137. The pedal shaft 132, second output gear 146, second one-way bearing 136, coupling 148, and/or chain wheel 140 can rotate together in a first rotational direction (e.g., forward rotational direction) when the user is pedaling pedals coupled to the cranks 130 in the first rotation direction to provide forward motive power.

In operation, to deliver motive power via the pedal assembly 110 without the motor assembly 160, the pedal shaft 132 can be rotated in a first direction by way of application of one or more forces to pedals 112 coupled to the cranks 130 to deliver rotational power to the chain wheel 140 coupled to the second output gear 146 (e.g., which can be by way of coupling 148), as schematically illustrated by the power path shown in FIG. 4B. When the pedal shaft 132 rotates in a first direction (e.g., forward rotational direction), the second one-way bearing 136 and the second output gear 146 can also rotate in the first direction (e.g., forward direction), which can cause the vehicle 100 to travel in a forward direction via power transmitted to the chain wheel 140 (e.g., by way of a chain looped around the chain wheel 140 and a sprocket of the driven wheel 102). The user can apply one or more forces in the first rotational direction to pedals 112 coupled to the cranks 130 to rotate the pedal shaft 132 in the first rotational direction such that the second one-way bearing 136, second output gear 146, coupling 148, and/or chain wheel 140 rotate in the first rotational direction. The rotation of the chain wheel 140 in the first rotational direction can drive rotation of the driven wheel 102 (e.g., rear wheel) in the first rotational direction by way of a chain routed around the chain wheel 140 and a sprocket coupled to the driven wheel 102.

The second one-way bearing 136 can provide a conditional rotational coupling between the pedal shaft 132 and the second output gear 146. Rotation of the second one-way bearing 136 in one direction can cause the inner race and the outer race of the second one-way bearing 136 to move with each other and lock relative to each other (e.g., be rotationally locked together) to provide rotational coupling (e.g., rotationally locked together) between the pedal shaft 132 and the second output gear 146. For example, the second one-way bearing 136 can lock when rotated in the first rotational direction such that the inner race of the second one-way bearing 136 is restricted from moving relative to the outer race of the second one-way bearing 136, which can allow a transmission of torque from the pedal shaft 132 to the second output gear 146 to rotate the chain wheel 140 coupled to the second output gear 146 by way of the coupling 148. Rotation of the second output gear 146 can drive rotation of the chain wheel 140 in order to deliver a power output to (e.g., rotate) the driven wheel 102 to move the vehicle 100 in a desired (e.g., forward) direction. When the pedal shaft 132 is rotated in a second rotational direction (e.g., opposite the first rotation direction), the second one-way bearing 136 can slip such that the pedal shaft 132 and the second output gear 146 do not rotate together in the second rotational direction (e.g., not rotationally coupled). The second one-way bearing 136 can isolate rotation of the pedal shaft 132 in the second rotational direction from the second output gear 146. For example, the second one-way bearing 136 can slip when the outer race coupled to the second output gear 146 and inner race of the second one-way bearing 136 coupled to the pedal shaft 132 move independently of each other (e.g., not together) when the pedal shaft 132 is rotated in the second (opposite) direction.

When the second output gear 146 is driven in the first rotational direction by other means (e.g., those excluding the pedal shaft 132 and one or more cranks 130), such as the motor assembly 160, the second one-way bearing 136 can slip (e.g., the rotational movement of the outer race of the second one-way bearing 136 coupled to the second output gear 146 can be independent of the rotational movement of the inner race coupled to the pedal shaft 132). This slippage can prevent a transmission of torque from the second output gear 146 to the pedal shaft 132. This slippage can prevent or lessen rotational resistance by the pedal shaft 132 on rotation of the second output gear 146 driven by the motor assembly 160.

The second output gear 146 can interface (e.g., engage) with the first output gear 144 that is driven by the motor assembly 160. However, when the second output gear 146 is powered by (e.g., receives a transmitted torque from) the rotation of the pedal shaft 132 in the first rotational direction, the first output gear 144 can freely rotate in a second rotational direction (e.g., rotational direction opposite the first rotational direction) about the first one-way bearing 134 due to slippage of the first one-way bearing 134 (e.g., an outer race of the first one-way bearing 134 can slip relative to an inner race of the first one-way bearing 134, which can include the outer race rotating independently relative to the inner race). With the pedal shaft 132 rotating in the first rotational direction as a result of pedaling by the user in the first rotational direction, the first output gear 144 can rotate freely about a motor shaft 162 in the second rotational direction that can be driven by the motor assembly 160 due to slippage by the first one-way bearing 134 (e.g., an outer race of the first one-way bearing 134 coupled to the first output gear 144 can rotate independently relative to the inner race of the first one-way bearing 134 coupled to the motor shaft 162 that can be driven by the motor assembly 160). Therefore, torque is not transmitted from the pedal shaft 132 being driven in the first rotational direction by pedaling to the motor shaft 162 of the motor assembly 160.

The first one-way bearing 134 and/or the second one-way bearing 136 can include any suitable one-way bearing such as sprag bearings, and/or bearings with intermediate ball bearings or other bearing members, such as needle bearings, being biased (e.g., with a spring) within an asymmetrical retaining space.

As mentioned above, the gearbox 120 also can include a motor assembly 160. The motor assembly 160 can rotate the driven wheel 102 in the first rotational direction (e.g., by way of the interface between the first output gear 144 and second output gear 146) to propel the vehicle 100 in a desired direction (e.g., forward). The motor assembly 160 can rotate the motor shaft 162 and the first output gear 144 coupled to the motor shaft 162 in a second rotational direction which can rotate the second output gear 146 interfaced with the first output gear 144 in the first rotational direction, which can drive the driven wheel 102 in the first rotational direction.

The motor assembly 160 can include a motor shaft 162. The motor shaft 162 can rotate about a first rotational axis 135, which can be generally parallel to the second rotational axis 137. The motor shaft 162 can be driven by the motor assembly 160 in the second rotational direction. The motor shaft 162 can cause the first one-way bearing 134 and the first output gear 144 to rotate in the second rotational direction (e.g., counterclockwise direction when viewed from the right side of the vehicle 100) to move the vehicle 100 forward.

The first one-way bearing 134 can be coupled to and coaxial with the first output gear 144 and the motor shaft 162. The first one-way bearing 134 can be disposed radially between the first output gear 144 and the motor shaft 162. The first one-way bearing 134 can include an outer race coupled to the first output gear 144 and an inner race coupled to the motor shaft 162. The first one-way bearing 134 can lock (e.g., the outer race and the inner race can rotate together) with the motor shaft 162 being driven by the motor assembly 160 in the second rotational direction such that the motor shaft 162 and the first output gear 144 rotate together in the second rotational direction. In some configurations, rotation of the motor shaft 162 can cause the first one-way bearing 134 to lock such that the first output gear 144 rotates with the motor shaft 162 in the second rotational direction. The first one-way bearing 134 can lock (e.g., when rotated in the second rotational direction) when rotational movement of the inner race of the first one-way bearing 134 and the outer race of the first one-way bearing 134 is coupled together (e.g., the inner race and the outer race rotate together, the inner race and the outer race cannot rotate independently relative to each other), which can allow for a transmission of torque from the motor shaft 162 to the first output gear 144.

In some variants, motive power for the vehicle 100 can be delivered by way of the motor assembly 160 without motive power from rotation of the pedal shaft 132 from pedaling. The motor assembly 160 can drive rotation of the motor shaft 162. To control the speed or torque of the motor assembly 160, one or more elements or gears can be configured to step down or reduce the rotational speed (e.g., revolutions per minute) of the motor shaft 162.

The motor assembly 160 can be powered with a throttle, such as a thumb throttle, that a user can adjust. The motor reducer assembly 160 can propel the vehicle 100 without use of the pedal assembly 110 (e.g., one or more cranks 130, pedals, and/or pedal shaft 132).

The power path for delivering power with the motor assembly 160 without pedaling (e.g., alone) is shown in FIG. 4C. The motor assembly 160 can rotate the motor shaft 162 in the second rotational direction. The first one-way bearing 134 can lock such that the first output gear 144 rotates with the motor shaft 162. The first output gear 144 can interface with the second output gear 146 to drive rotation of the second output gear 146. The second one-way bearing 136 can slip (e.g., independent rotation of the outer race of the second one-way bearing 136 relative to the inner race of the second one-way bearing 136) to enable the second output gear 146 to rotate independently (e.g., freely) relative to the pedal shaft 132, which can enable rotation of the second output gear 146 without rotating the pedal shaft 132, cranks 130, and pedals. The second output gear 146 can be coupled to the chain wheel 140 by way of the coupling 148 such that the second output gear 146 and the chain wheel 140 rotate together. The rotation of the chain wheel 140 can drive a chain coupled to a sprocket of the driven wheel 102 such that the driven wheel 102 rotates to propel the vehicle 100. When the second output gear 146 is rotated by the first output gear 144, the second one-way bearing 136 can slip, which can prevent torque from being delivered to the pedal shaft 132 by way of the second one-way bearing 136 or the second output gear 146. This can inhibit or prevent the one or more cranks 130 from rotating when rotation of the driven wheel 102 is powered by the motor assembly 160 to enable a user to ride and power the vehicle 100 without pedaling. The first output gear 144 can interface (e.g., mesh, engage) with the second output gear 146. A rotation of the first output gear 144 can cause an opposite rotation of the second output gear 146 (e.g., in the clockwise direction when viewed from right side of vehicle 100) which can provide rotational power or torque to the chain wheel 140. In some variants, driving by the motor assembly 160 (e.g., rotation of the first output gear 144) does not cause rotation of the pedal shaft 132.

In some variants, the first output gear 144 and the second output gear 146 can be sized and/or configured to have a 1:1 gear ratio (e.g., the first output gear 144 and the second output gear 146 can have the same diameter, the first output gear 144 can have the same amount of teeth as the second output gear 146). In some variants, the first output gear 144 and second output gear 146 can have a different gear ratio than 1:1. For example, the first output gear 144 can be smaller in diameter and/or have a fewer number of gear teeth than the second output gear 146. The second output gear 146 can be larger in diameter and/or have more gear teeth than the first output gear 144. In some variants, the first output gear 144 can be larger in diameter and/or have more gear teeth than the second output gear 146.

In some variants, the vehicle 100 can be simultaneously powered by both the motor assembly 160 and the pedal assembly 110 (e.g., rotation of the pedal shaft 132 by way of a user pedaling the one or more cranks 130). The power path for delivering power simultaneously with the motor assembly 160 and the power assembly 110 is schematically illustrated in FIG. 4D. When the user applies a force to the one or more cranks 130 to rotate the pedal shaft 132, the second one-way bearing 136 can lock and transmit a torque to the second output gear 146. When the user powers the motor assembly 160, the motor shaft 162 can rotate and lock the first one-way bearing 134, which can transmit torque to the first output gear 144 that is interfaced with the second output gear 146 to then rotate the second output gear 146. Therefore, the chain wheel 140 can receive power simultaneously from the motor assembly 160 and the pedal assembly 110 (e.g., rotation of the pedal shaft 132) such that the vehicle 100 is operated in a motor-assisted mode, wherein a rider can use the motor assembly 160 to provide supplemental motive power to the vehicle 100 while pedaling.

In some variants, the first one-way bearing 136 or the second one-way bearing 136 can slip when the pedal assembly 110 and the motor assembly 160 are being simultaneously operated to avoid the motor assembly 160 driving rotation of the pedal shaft 132 and the pedal assembly 110 driving rotation of the motor shaft 162. For example, when the motor assembly 160 is driving rotation of the second output gear 146 faster than the pedal assembly 110 the second one-way bearing 136 can slip such that the second output gear 146 rotates faster than the pedal shaft 132, which can keep the motor assembly 160 from rotating the pedal shaft 132 and cranks 130 coupled thereto. When the pedal assembly 110 is being pedaled at a rate to drive rotation of the first output gear 144 faster than the motor assembly 160, the first one-way bearing 136 can slip such that the first output gear 144 rotates faster than the motor shaft 162, which can keep the pedal assembly 110 from driving rotation of the motor shaft 162. In some variants, the rotation of the chain wheel 140, can be driven by either the pedal assembly 110 or the motor assembly 160 depending on which is driving faster rotation of the second output gear 146.

The motor assembly 160 can be controlled in various ways. For example, the motor assembly 160 can provide motive force that supplements (e.g., adds) to motive force provided by the user via the pedals. In some variants, the motor assembly 160 can provide motive force when the user is not pedaling. In some variants, the motor assembly 160 can provide motive force when the user is pedaling. In some variants, the vehicle 100 can include a sensor, such as a torque, proximity, and/or other sensor, that can be used in control of the motor. For example, the motor assembly 160 can be actuated when a threshold torque level is detected and/or exceeded. This can enable automatic locomotion assistance by the motor assembly 160 and/or can permit a user to control operation of the motor by use of the pedal assembly, such as by applying an amount of torque to the pedal assembly that is greater than or equal to the threshold. In some variants, the propulsion of the vehicle 100 can be concurrently powered by the motor assembly 160 and the user by way of the pedal assembly 110.

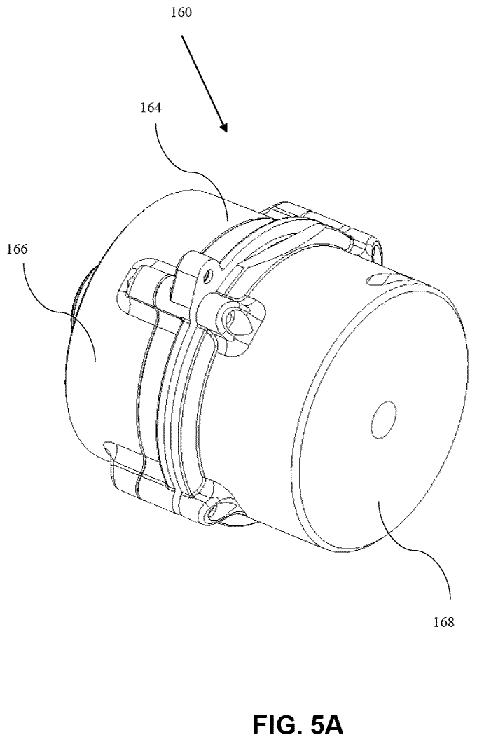

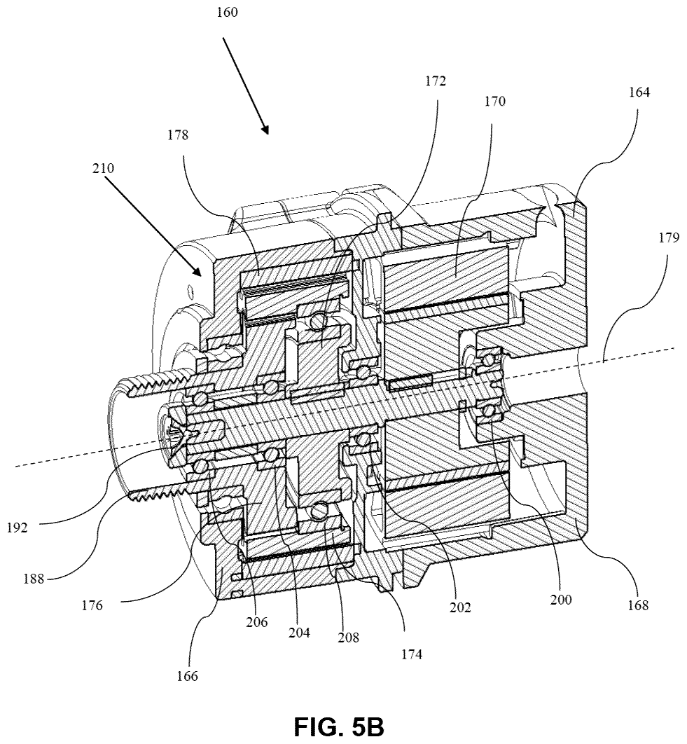

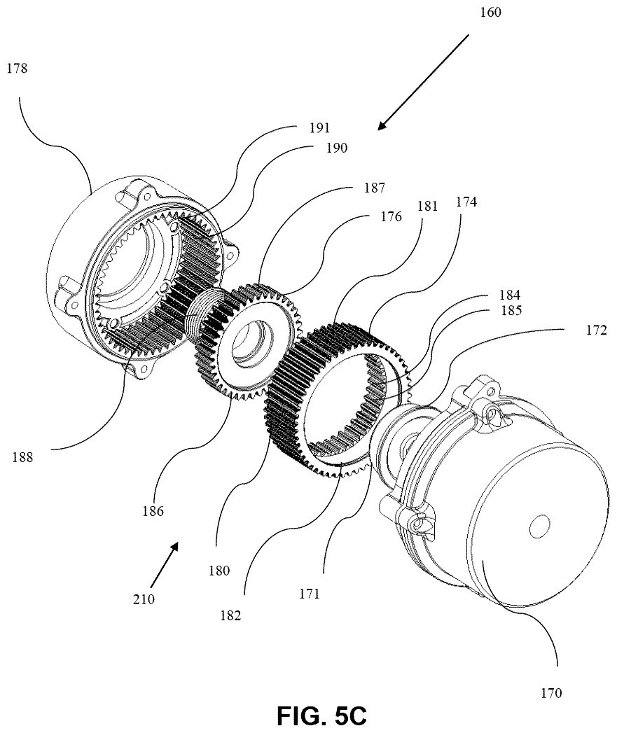

### E. Motor Assembly—FIGS. 5A-5C

FIGS. 5A-5C show an embodiment of the motor assembly 160. The motor assembly 160 can include a housing 164 with a first portion 166 and a second portion 168. The motor assembly 160 can include a motor 170 (e.g., an electric motor).

The motor assembly 160 can include a reducer 210 (e.g., such as a reducer assembly or motor reducer assembly). The reducer 210 can include a high gear reduction ratio (e.g., 1:5, 1:6, 1:10, 1:20) to reduce the output rotational speed of the motor 170 and/or provide increased torque from the motor 170 to the driven wheel 102, which can assist the vehicle 100 in moving from a resting position and/or climbing an incline. The reducer 210 can include a variety of different gears having different gear diameter sizes and/or different numbers of gear teeth that interface with each other to reduce a first rotational speed of an output shaft of the motor 170 to a second slower rotational speed of the motor shaft 162 that is coupled to the first output gear 144.

The reducer 210 can include a cam 172, a gear disk 174, an output gear 176 (e.g., reducer output gear), and/or a ring gear 178. The cam 172 can have an eccentric profile and/or can be designed to rotate eccentrically. For example, the cam 172 can have an ellipsoidal profile and/or can be designed to rotate about an axis of rotation that is not collinear with an axis of rotation 179 of the motor 170. The axis of rotation of the cam 172 can be ellipsoidal or follow an ellipsoidal path during operation. the gear disk 174 can be coupled to the cam 172. The gear disk 174 can have an outer portion 180 with a plurality of gear teeth 181. The gear disk 174 can include a first inner portion 182 and a second inner portion 184 axially spaced apart from each other. The first inner portion 182 can be free of gear teeth and can be coupled to the cam 172 (e.g., coupled to an outer surface 171 of the cam 172). In some variants, the first inner portion 182 of the gear disk 174 can include a bearing (e.g., a ball or roller bearing). The second inner portion 184 can have a plurality of gear teeth 185.

The ring gear 178 can interface with the gear disk 174. The ring gear 178 can have a plurality of gear teeth 191 located on an inner surface 190 of the ring gear 178. The plurality of gear teeth 191 located on the inner surface 190 can interface (e.g., engage, mate) with the plurality of gear teeth 181 of the outer portion 180 of the gear disk 174. The number of gear teeth on the gear disk 174 can differ from (e.g., be unequal to) the number of gear teeth on the inner surface 190 of the ring gear 178. For example, the number of gear teeth 191 on the inner surface 190 can be greater than the number of teeth 181 on the outer portion 180 of the gear disk 174. This gear reduction ratio (e.g., a gear reduction ratio of 2:3, 1:2, 1:3, 1:4, 1:5) can lead to a reduction in rotational speed from the motor 170 to the gear disk 174.

The output gear 176 can interface with the gear disk 174. The output gear 176 can have an outer surface 186 with a plurality of gear teeth 187. In some variants, the second inner portion 184 of the gear disk 174 can have a plurality of gear teeth 185 that can interface with the gear teeth 187 of the outer surface 186 of the output gear 176. The amount of gear teeth 187 on the outer surface 186 can be less than the amount of gear teeth 185 on the second inner portion 184 of the gear disk 174. The gear ratio between the gear teeth 187 of the output gear 176 and the gear teeth 185 of the gear disk 174 can be 2:3, 1:2, 1:3, 1:4, 1:5, and/or any ratio capable of reducing the rotational speed from the motor 170 to the output gear 176. Rotation of the gear disk 174 can cause the output gear 176 to rotate. The output gear 176 can be coupled to the first one-way bearing 134 and first output gear 144 by way of member 188 (e.g., a shaft, threaded shaft, cylindrical mount, or otherwise). The member 188 can be integral with the output gear 176. The member 188 can be the motor shaft 162. The member 188 can be coupled to the motor shaft 162. The member 188 can transfer rotation from the output gear 176 to the first one-way bearing 134 outside of the housing 164 to provide motive power to the vehicle 100.

In operation, the motor 170 can drive rotation of the cam 172 at a first speed (e.g., desired speed). The output rotational speed of the motor 170 driving the cam 172 can be controlled by a user (e.g., with a throttle). The cam 172 is rotatably coupled to first inner portion 182 of the gear disk 174. Therefore, the cam 172 can rotate the gear disk 174 at slower speed, relative to the cam 172 due to the irregular profile of the cam 172. For example, since ellipsoidal profile of the cam 172 is not rigidly coupled (e.g., via gears) to the first inner portion 182 and the first inner portion 182 can slip relative to the cam 172, the rotational speed transferred from the motor 170 to the gear disk 174 is reduced. Additionally, the cam 172 can rotate the gear disk 174 about an irregular path (e.g., ellipsoidal) or profile which differs from that of the axis of rotation 179 of motor 170. The gear disk 174 can rotate relative to the ring gear 178.

In various implementations, the ring gear 178 can provide rotational speed reduction (e.g., reduction of the rotational speed of the output gear 176 relative to the rotational speed of the motor 170). The ring gear 178 can remain fixed (e.g., remains stationary). When the outer portion 180 of the gear disk 174 (via the plurality of gear teeth 181) contacts the fixed inner surface 190 of the ring gear 178 (via the plurality of gear teeth 191), the rotational speed of the gear disk 174 can slow or further reduce (e.g., more than the reduction solely due to the interaction between the gear disk 174 and the cam 172). Furthermore, the gear disk 174 rotates about an axis of rotation that differs from the axis of rotation 179 because the gear disk 174 rotates about an irregular profile (e.g., the cam 172 surface profile, ellipsoidal path). Additionally, the plurality of gear teeth 181 of gear disk 174 engages the plurality of gear teeth 191 of the inner surface 190 of the ring gear 178 irregularly due to the moving of the axis of rotation of the gear disk 174. When the plurality of gear teeth 181 of the outer portion 180 of the gear disk 174 contact the plurality of gear teeth 191 of inner surface 190 of the ring gear 178 the rotational speed of the gear disk 174 is further reduced.

The output gear 176 is operable to transmit torque (e.g., rotation) from the motor 170 to the first one-way bearing 134 to the driven wheel 102. Advantageously, the configuration of the reducer 210 (e.g., cam 172, gear disk 174, output gear 176, and/or ring gear 178) can reduce (e.g., decrease) the speed of the motor 170 and increase the amount of torque delivered to the vehicle 100 (e.g., the driven wheel 102). The output gear 176 is positioned over a shaft 192 of the motor 170 extending through the cam 172. The gear disk 174 can reduce the speed that the motor 170 drives the output gear 176 due to the interaction between (e.g., relative positioning of) the cam 172, gear disk 174, output gear 176, and/or ring gear 178. The gear teeth 185 of the second inner portion 184 of the gear disk 174 can interface (e.g., engage) with the plurality of gear teeth 187 of the outer surface 186 of the output gear 176. The second inner portion 184 can reduce the speed of the output gear 176 due to the slower rotational speed of the gear disk 174. The configuration of the reducer 210 described herein can enable a significant rotational speed reduction (e.g., due to the high gear reduction ratio) from the motor 170 to the output gear 176, and therefore to the chain wheel 140 and the driven wheel 102. For example, the motor 170 can drive rotation at a first rotational speed and the output gear 176 can rotate at a second, slower rotational speed. Advantageously, this can allow high torque to be delivered to the driven wheel 102 while having a motor 170 small enough to be placed on an e-bike.

The motor 170 can include a drive shaft 192 that can be driven (e.g., rotated) by the motor 170. The motor unit 160 can include a plurality of bearings disposed on the drive shaft 192 to isolate one or more features of the motor unit 160 from the rotation of the drive shaft 192. For example, the motor unit 160 can include a first bearing 200 and/or a second bearing 202 disposed between portions of the housing 164 and the motor shaft 192 to isolate rotation of the drive shaft 192 from the housing 164. The motor unit 160 can include a third bearing 204 and/or a fourth bearing 206 disposed between the output gear 176 and the motor shaft 192 to isolate rotation of the drive shaft 192 from the output gear 176.

The cam 172 can be coupled (e.g., fixedly coupled) to the drive shaft 192. The cam 172 can rotate with the drive shaft 192. As described herein, the gear disk 174 can be disposed on (e.g., coupled to) the cam 172, which can include being disposed around an outer periphery of the cam 172. The cam 172 can include an eccentric profile, which can be a profile that includes outer peripheral contours that deviate from circular. In some variants, the motor unit 160 can include a bearing 208 disposed between the cam 172 and the gear disk 174. The bearing 208 can facilitate some slipping between the cam 172 and the gear disk 174.

The gear disk 174 can be disposed within the ring gear 178. The ring gear 178 can be fixedly coupled to or integral with the housing 164 (e.g., second portion 168). The rotation of the cam 172 can drive movement and/or rotation of the gear disk 174 along an ellipsoidal path. The gear teeth 181 of the outer portion 180 of the gear disk 174 can interface with gear teeth 191 of the inner surface 190 of the ring gear 178, which can manage (e.g., lower) the rotational speed of the gear disk 174 relative to the rotational speed of the drive shaft 192.

As described herein, the output gear 176 can be disposed on the drive shaft 192 with the third bearing 204 and the fourth bearing 206 disposed between the drive shaft 192 and the output gear 176 such that the rotation of the drive shaft 192 does not directly drive rotation of the output gear 176. Instead, the movement and/or rotation of the gear disk 174 can drive rotation of the output gear 176. As described herein, the gear teeth 185 of the second inner portion 184 of gear disk 174 can interface with the gear teeth 187 of the outer surface 186 of the output gear 176 to drive rotation of the output gear 176, which can manage (e.g., lower) the rotational speed of the output gear 176 relative to the rotational speed of the gear disk 174. The first output gear 144 can be coupled to the portion (e.g., member 188) of the output gear 176 that protrudes outside of the housing 164. As described herein, the portion (e.g., member 188) can be the motor shaft 162. The rotational speed reduction can at least provide the benefits described herein.

### E. Certain Terminology

Certain terminology may be used in the following description for the purpose of reference only, and thus is not intended to be limiting. For example, terms such as “upper”, “lower”, “upward”, “downward”, “above”, “below”, “top”, “bottom”, “left”, and similar terms refer to directions in the drawings to which reference is made. Such terminology may include the words specifically mentioned above, derivatives thereof, and words of similar import. Similarly, the terms “first”, “second”, and other such numerical terms referring to structures neither imply a sequence or order unless clearly indicated by the context.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “spherical” or “circular” or “cylindrical” or “semi-circular” or “semi-cylindrical” or any related or similar terms, are not required to conform strictly to the mathematical definitions of spheres, circles, cylinders or other structures, but can encompass structures that are reasonably close approximations.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees. As another example, in certain embodiments, as the context may permit, the term “generally perpendicular” can refer to something that departs from exactly perpendicular by less than or equal to 20 degrees.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Some embodiments have been described in connection with the accompanying drawings. The figures are drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### F. Summary

Various embodiments and examples of mid-drive motorized drive units, and associated vehicles and methods, have been disclosed herein. Although the invention has been disclosed in the context of certain embodiments and examples, it will be understood by those skilled in the art that this disclosure extends beyond the specifically disclosed embodiments to other alternative embodiments and/or uses of the embodiments and certain modifications and equivalents thereof. The scope of the present disclosure is not intended to be limited by the specific disclosures of preferred embodiments in this section or elsewhere in this specification, and may be defined by claims as presented in this section or elsewhere in this specification or as presented in the future.

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope of the disclosure. Any feature from one embodiment can be included in any other embodiment. No element, feature, step, or aspect is critical or essential.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

What is claimed is:

1. A motorized mid-drive unit configured to drive a bicycle having one or more cranks and a driven wheel, the motorized mid-drive unit comprising:
an electric motor;
a reducer comprising:
an eccentric cam;
a gear disk coupled to the eccentric cam;
a ring gear interfaced with outward-facing teeth of the gear disk; and
a reducer output gear interfaced with inward-facing teeth of the gear disk;
one or more gears;
a first one-way bearing; and
a second one-way bearing;
wherein the first one-way bearing is configured to enable power from the electric motor to be delivered to the driven wheel;
wherein the second one-way bearing is configured to enable power from the one or more cranks to be delivered to the driven wheel;
wherein the reducer is configured to reduce a rotational speed output from the electric motor and delivered to the driven wheel; and
wherein the motorized mid-drive unit is configured to enable a user to propel the bicycle with the one or more cranks alone, with the electric motor alone, and simultaneously with the one or more cranks and the electric motor.

2. The motorized mid-drive unit of claim 1, wherein the one or more gears comprises a chain wheel configured to receive power from the electric motor and the one or more cranks to deliver the power to the driven wheel by way of a chain.

3. The motorized mid-drive unit of claim 2, wherein the one or more gears comprises an output gear and further comprising a pedal shaft rotationally coupled to the one or more cranks, wherein the chain wheel is rotationally coupled to the output gear and the output gear is rotationally coupled to the pedal shaft, and wherein the output gear is rotationally coupled to the pedal shaft by the second one-way bearing.

4. The motorized mid-drive unit of claim 2, wherein the one or more gears comprises a first output gear and a second output gear, wherein the first output gear is interfaced with the second output gear, wherein the first output gear is configured to facilitate delivering power from the electric motor to the chain wheel, and wherein the second output gear is configured to facilitate delivering power from the electric motor and the one or more cranks to the chain wheel.

5. The motorized mid-drive unit of claim 4, wherein the first one-way bearing is coupled to the first output gear and the second one-way bearing is coupled to the second output gear, wherein rotation of an inner race of the first one-way bearing in a first direction locks the first one-way bearing to facilitate delivering power from the electric motor to the first output gear, and wherein rotation of an inner race of the second one-way bearing in a second direction locks the second one-way bearing to facilitate delivering power from the one or more cranks to the second output gear.

6. The motorized mid-drive unit of claim 1, wherein the eccentric cam is rotationally coupled to a motor shaft of the electric motor, and wherein the eccentric cam is coupled to the gear disk and configured to rotate the gear disk about an ellipsoidal path.

7. The motorized mid-drive unit of claim 6, wherein the ring gear is configured to reduce a rotational speed of the gear disk as the gear disk interfaces the ring gear along the ellipsoidal path.

8. The motorized mid-drive unit of claim 1, wherein the gear disk is configured to reduce a rotational speed of the reducer output gear, and wherein the reducer output gear is configured to facilitate delivering power from the electric motor to the driven wheel.

9. The motorized mid-drive unit of claim 1, wherein the gear disk has a first inner portion and a second inner portion axial spaced apart from each other, and wherein the first inner portion is interfaced with the eccentric cam, wherein the second inner portion is interfaced with the reducer output gear.

10. The motorized mid-drive unit of claim 1, wherein the gear disk is configured to increase an amount of torque from the electric motor and delivered to the driven wheel.

11. A gearbox for a vehicle comprising a driven wheel and a pedal assembly including a chain wheel and a shaft, the gearbox comprising:
a motor assembly comprising an output shaft;
a motor reducer assembly comprising:
a cam disposed on the output shaft, the cam comprising an eccentric profile;
a gear disk coupled to the cam;
a ring gear interfaced with outer teeth of the gear disk; and
an output gear interfaced with inner teeth of the gear disk;
wherein the motor reducer assembly is configured to drive rotation of the output gear at a reduced speed relative to a rotational speed of the output shaft of the motor assembly;
a first one-way bearing coupled to the output gear;
a first output gear coupled to the first one-way bearing;
a second one-way bearing configured to be coupled to the shaft of the pedal assembly; and
a second output gear coupled to the second one-way bearing, the second output gear interfaced with the first output gear and coupled to a chain wheel of the pedal assembly;
wherein the motor assembly is configured to rotate the output shaft to drive rotation of the first output gear to rotate the second output gear and chain wheel to drive rotation of the driven wheel to propel the vehicle;
wherein the shaft of the pedal assembly is configured to rotate from pedaling to drive rotation of the second output gear and the chain wheel to drive rotation of the driven wheel to propel the vehicle;
wherein the first one-way bearing is configured to slip to enable the shaft of the pedal assembly to drive rotation of the second output gear without driving rotation of the output shaft; and
wherein the second one-way bearing is configured to slip to enable the output shaft of the motor assembly to drive rotation of the first output gear to rotate the second output gear without driving rotation of the shaft of the pedal assembly.

12. The gearbox of claim 11, wherein the first one-way bearing and the second one-way bearing are configured to slip to enable simultaneous rotation of the output shaft and the shaft of the pedal assembly.

13. The gearbox of claim 11, wherein the interface between the ring gear and the outer teeth of the gear disk is configured to slow rotation of the gear disk relative to the output shaft, and wherein the ring gear and the gear disk are configured to increase a torque delivered by the motor assembly.

14. The gearbox of claim 11, wherein the interface between the output gear and the inner teeth of the gear disk is configured to slow rotation of the output gear relative to the gear disk.

15. The gearbox of claim 11, wherein the cam is configured to rotate the gear disk on an ellipsoidal path, and wherein the ellipsoidal path is off an axis of rotation of the output shaft.

16. A motor unit for a vehicle with a pedal assembly, the motor unit comprising:
a motor assembly comprising an output shaft;
a motor reducer assembly comprising:
a cam disposed on the output shaft, the cam comprising an eccentric profile;
a gear disk coupled to the cam;
a ring gear interfaced with outer teeth of the gear disk; and
an output gear interfaced with inner teeth of the gear disk;
wherein the motor reducer assembly is configured to drive rotation of the output gear at a reduced speed relative to a rotational speed of the output shaft of the motor assembly.

17. The motor unit of claim 16, wherein the interface between the ring gear and the gear disk is configured to increase a torque delivered by the motor assembly.

18. The motor unit of claim 16, wherein the interface between the ring gear and the outer teeth of the gear disk is configured to slow rotation of the gear disk relative to the output shaft.

19. The motor unit of claim 16, wherein the interface between the output gear and the inner teeth of the gear disk is configured to slow rotation of the output gear relative to the gear disk.

20. The motor unit of claim 16, wherein the cam is configured to rotate the gear disk on an ellipsoidal path.
